(19) United States
(12) Patent Application Publication
(10) Pub. No.: US 2012/0131797 A1
(43) Pub. Date: May 31, 2012

(54) Processing Method of Tube Body, Manufacturing Method of Cylinder Device and Cylinder Device Manufactured By the Same

(75) Inventor: Kazunori Minoguchi, Kanagawa (JP)

(73) Assignee: Hitachi, Ltd., Kanagawa (JP)

(21) Appl. No.: 13/305,430

(22) Filed: Nov. 28, 2011

Related U.S. Application Data
(63) Continuation of application No. 12/078,228, filed on Mar. 28, 2008, now abandoned.

(30) Foreign Application Priority Data
Mar. 30, 2007 (JP) 2007-94307
Feb. 20, 2008 (JP) 2008-38918

(51) Int. Cl. B23P 15/00

(52) U.S. Cl. 29/890.09

(57) ABSTRACT

There is provided a processing method of a tube body comprising the steps of: a tube-expanding step wherein a base tube is partially retained with a chuck unit having a rotational function, and a mandrel is pressed in to an end portion of the base tube so as to expand the end portion of the base tube; and a rotation ironing step wherein the chuck unit rotates the base tube together with the mandrel, a roller die is pressed against an outer-periphery surface of the end portion of the base tube and the roller die is moved with respect to the base tube and in an axial direction thereof so as to deform an inner-periphery surface of the end portion of the base tube into a shape corresponding to an external shape of the mandrel.

### CROSS REFERENCES TO RELATED APPLICATIONS

This is a continuation of application Ser. No. 12/078,228, filed Mar. 28, 2008. The present application claims priority based on Japanese Patent Applications No. 2007-94307, filed Mar. 30, 2007 and No. 2008-38918 filed Feb. 20, 2008, the entirety of which being incorporated herein by reference.

### BACKGROUND OF THE INVENTION

1. Field of the Invention

The present invention relates to a processing method of a tube body wherein thickness of an end portion of the tube body is reduced by plastic working so as to finish in a predetermined dimension, a manufacturing method of a cylinder device using the processing method, and the cylinder device manufactured by the same.

2. Description of the Related Art

For example, as regards a hydraulic damper (shock absorber) of a twin tube type, as shown in FIGS. 11 and 12, an inner cylinder 1 slidably housing a piston 8 is introduced into an outer cylinder 2 with a base. One end of a piston rod 3, opposite to the other end connected to the piston 8, is inserted into a rod guide 4 and an oil seal 5 both installed in an open end of the inner cylinder 1 and the outer cylinder 2 so as to extend outside. According to extension and compression movement of the piston rod 3, damping force will be generated by flow resistance of hydraulic fluid flowing through a piston valve PV and a bottom valve BV. Furthermore, inflow and out flow of the hydraulic fluid according to compression and extension of the piston rod 3 can be compensated by a reservoir 6 provided between the inner cylinder 1 and the outer cylinder 2.

In this type of hydraulic damper, the rod guide 4 and the oil seal 5 are fitted into the open end of the outer cylinder 2 and prevented from falling off with a bended segment 2a which is an end portion of the outer cylinder 2 being bended inside in a radial direction. Further, at the end portion of the outer cylinder 2, a cap 7 for receiving a bump stopper 9 is installed in such a condition that the cap 7 is pressed-in to the outer periphery of the outer cylinder 2. The cap 7 is provided with a plurality of (for example, three) projections 7a on the inner bottom side thereof so as to fix in an axial direction by abutting the projections 7a to the bended segment 2a.

Here, as regards the end portion of the outer cylinder 2 described hereinabove, its internal diameter side is applicable as a fitting portion of the rod guide 4 and the oil seal 5 while its external diameter side is applicable as a press-fitting portion of the cap 7. Accordingly, not only dimensions of those internal and external diameters, but also concentricity, circularity, etc. of the end portion of the outer cylinder 2 should be highly precise. Further, in order not to damage the oil seal 5 in assembly, it is required for the inner surface of the end portion of the outer cylinder 2 to maintain well-conditioned surface roughness. Still further, to smoothly perform bending of the bended segment 2a, it is desirable that thickness of the end portion of the outer cylinder 2 is as thin as possible. Especially, in case of a hydraulic damper for a strut suspension, thickness of the outer cylinder 2 will be relatively large, whereby it is required to make the end portion of the outer cylinder 2 thinner.

As discussed above, the external diameter of the outer cylinder 2 is used as the press-fitting portion of the cap 7 thereby being necessary to retain a predetermined dimension for the external diameter. Accordingly, as regards the hydraulic damper for the strut suspension, the end portion of the outer cylinder 2 is made to be thin normally by cutting the inner surface of the end portion of the outer cylinder 2 to form a multi-stepped portion. Specifically, as shown in FIG. 12, two types of diameter expanding portions are formed in a sequential manner: a first diameter expanding portion 2A, the internal diameter of which is slightly larger than a general portion (not the end portion including the first diameter expanding portion 2A and a second diameter expanding portion 2B); and a second diameter expanding portion 2B, the internal diameter of which is slightly larger than the first diameter expanding portion 2A. The first diameter expanding portion 2A is used as a fitting portion of the rod guide 4, and the second diameter expanding portion 2B is used as a fitting portion of the oil seal 5.

However, highly precise work will be needed to perform conventional methods in which the end portion of the outer cylinder 2 is processed by cutting work, so that it inevitably requires considerable time and man-hour, resulting in increase of work cost. Further, there is a risk that chips or burrs produced by the cutting work adhere to the inner surface of the outer cylinder 2, and then enter as foreign materials (contamination) into the hydraulic damper. Here, the purpose of finishing the end portion of the outer cylinder 2 to form the multi-stepped portion as discussed above is to minimize strength reduction caused by thinning as much as possible.

Based on the above, finishing the end portion of the outer cylinder 2 through plastic working has been well examined. For example, US Patent Application Publication 2005/0011245 A1 (hereinafter reference 1), a counterpart application of Japanese Patent Application Unexamined Publication No. 2003-225725, discloses the following processing method: a mandrel is inserted into a base tube; and an end portion of the base tube is attached to the mandrel by performing a parallel swaging work with a die. With this method, the end portion of the base tube is processed with ironing through the parallel swaging work by squeezing thereof between the mandrel and the die. Accordingly, it is possible to make the end portion of the outer cylinder 2 to be thin formation while maintaining precise dimension and well surface roughness.

However, according to the processing method of the reference 1, it would be necessary to obtain a predetermined area reduction rate through a single parallel swaging work. Thus, in case of obtaining the predetermined area reduction rate with respect to the hydraulic damper for the strut suspension in which to have a relatively thick outer cylinder (tube body), molding force necessary for the parallel swaging work needs to go over a buckling load of the base tube, being virtually incapable of molding such a hydraulic damper. Further, since the ironing is performed while squeezing the end portion of the base tube, the external diameter of the end portion of the outer cylinder 2 will be narrowed, whereby a design change may be required for sheathing parts such as the cap 7 to be pressed in or sheathing the end portion of the outer cylinder 2.

### SUMMARY OF THE INVENTION

The present invention has been made in light of the above problem, and it is an object of the present invention to provide a processing method of a tube body, a manufacturing method of a cylinder device and the cylinder device thereof being able to process an end portion of the tube body in a high degree of accuracy without depending on cutting work which generates chips or burrs when processing an inner periphery of the tube body.

In order to achieve the object described above, according to a first aspect of the present invention, there is provided a processing method of a tube body comprising the steps of: a tube-expanding step wherein a base tube is partially retained with a chuck unit having a rotational function, and a mandrel is pressed in to an end portion of the base tube so as to expand the end portion of the base tube; and a rotation ironing step wherein the chuck unit rotates the base tube together with the mandrel, a roller die is pressed against an outer-periphery surface of the end portion of the base tube and the roller die is moved with respect to the base tube and in an axial direction thereof so as to deform an inner-periphery surface of the end portion of the base tube into a shape corresponding to an external shape of the mandrel.

According to a second aspect of the present invention, there is provided a manufacturing method of a cylinder device comprising the steps of: a manufacturing step of manufacturing a cylinder by the processing method of a tube body according to claim 1; an assembling step of assembling interior parts including a piston, a piston rod and a rod guide into the cylinder; and a curling process of curling a tip end portion of the cylinder so as to prevent the interior parts from falling off.

According to a third aspect of the present invention, there is provided a cylinder device comprising: a cylinder; a rod adapted to be compressed into or extended from one end of the cylinder; a rod guide inserted into the one end of the cylinder so as to support the rod; and a curled portion formed by curling a tip end portion of the cylinder so as to prevent the rod guide from falling off from the cylinder, wherein the cylinder is formed by pressing a mandrel into an end portion of a base tube, and pressing a roller die against the base tube so as to deform an inner-periphery surface of the end portion of the base tube along an outer-periphery surface of the mandrel.

According to a fourth aspect of the present invention, there is provided a cylinder device comprising: a rod adapted to be compressed into or extended from one end of the cylinder; a rod guide inserted into the one end of the cylinder so as to support the rod; and a curled portion formed by curling a tip end portion of the cylinder so as to prevent the rod guide from falling off from the cylinder, wherein a thickness reduction rate of the one end of the cylinder is 50% or less.

With the present invention based on the above, it is possible to accurately process the end portion of the tube body without depending on any types of cutting work generating chips or burrs in process of the inner periphery of the tube body.

### BRIEF DESCRIPTION OF THE DRAWINGS

FIG. 1A, FIG. 1B and FIG. 1C are cross-sectional views sequentially showing a processing method of a tube body according to a first embodiment of the present invention, wherein: FIG. 1A shows a retaining process in which to retain a base tube at a chuck unit; FIG. 1B shows a tube-expanding process in which to press a mandrel into an end portion of the base tube; and FIG. 1C shows an initial stage of a rotation ironing process;

FIG. 2D, FIG. 2E and FIG. 2F are cross-sectional views of processing steps following FIG. 1C: FIG. 2D shows an initial stage of the rotation ironing process; FIG. 2E shows a final stage of the rotation ironing process; and FIG. 2F shows a final stage of the whole steps;

FIG. 3 is a side view showing a formation of the mandrel according to the present invention;

FIG. 4 is a cross-sectional view showing a formation of a tube after finishing work according to the present invention;

FIG. 5 is a cross-sectional view showing an assembling process of a cylinder device according to the present invention;

FIG. 6 is a cross sectional view showing the rotation ironing process in a modified example according to the first embodiment of the present invention;

FIG. 7 is a local cross-sectional view of the base tube in a modified example according to the first embodiment of the present invention;

FIG. 8 is a side view showing a formation of the mandrel according to a second embodiment of the present invention;

FIG. 9C′ and FIG. 9E′ are cross-sectional views sequentially showing a processing method of the tube body according to the second embodiment of the present invention, wherein: FIG. 9C′ shows an initial stage of a rotation ironing process; and FIG. 9E′ shows a final stage of the rotation ironing process;

FIG. 10G and FIG. 10H are cross-sectional views sequentially showing a processing method of the tube body according to the second embodiment of the present invention, wherein FIG. 10G shows an initial stage in which the mandrel is pulled out after completing the rotation ironing process and the end of the tube body is to be cut (end cutting process); and FIG. 10H shows a stage immediately after the end cutting process;

FIG. 11 is a cross-sectional view showing the whole structure of a hydraulic damper provided with an external cylinder subject to work of the present invention; and

FIG. 12 is a cross-sectional view showing a local structure of the hydraulic damper of FIG. 11.

### DETAILED DESCRIPTION OF THE PREFERRED EMBODIMENTS

Preferred embodiments of the present invention will be described with reference to the accompanying drawings.

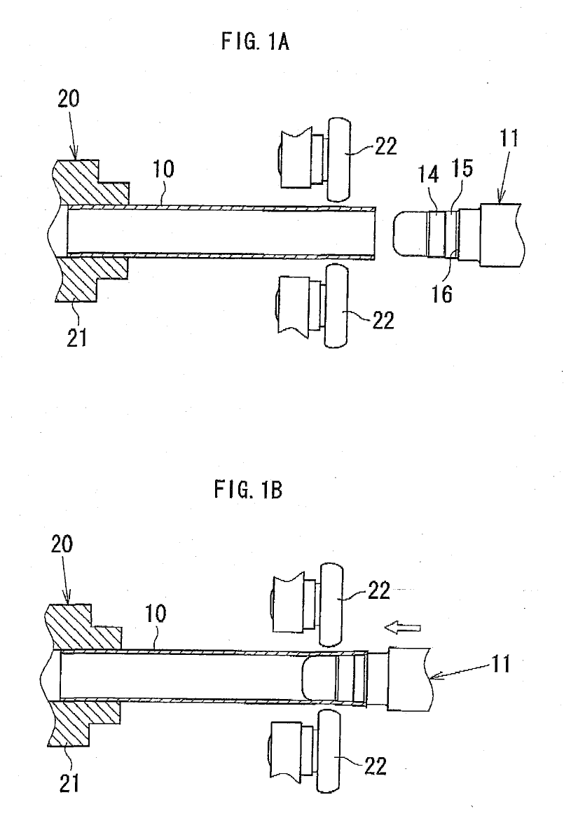

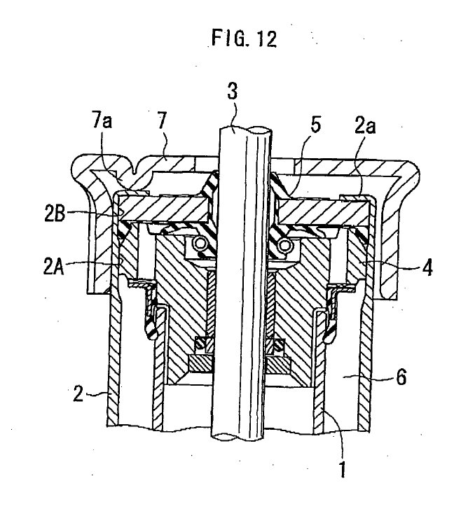

FIGS. 1 to 3 show a processing method of a tube body in sequence according to a first embodiment of the present invention. The first embodiment of the present invention is to finish an end portion of an outer cylinder 2 (tube body) of a hydraulic damper as shown in FIGS. 11 and 12 to be thin and in a predetermined dimension by plastic working. At the end portion of the outer cylinder 2 after finishing work, as shown in FIG. 4, a first diameter expanding portion 2A functioning as a fixing portion of a rod guide 4 and a second diameter expanding portion 2B functioning as a fixing portion of a oil seal 5 are formed in continuity. Further, a taper surface 2C in a chamfer formation is formed at an inner edge of an opening end of the outer cylinder 2. An inner diameter dA of the first diameter expanding portion 2A is made to be slightly larger than an inner diameter d0 of the other portion (hereinafter general portion) while an inner diameter dB of the second diameter expanding portion 2B is set slightly larger than the inner diameter dA of the first diameter expanding portion 2A. On the other hand, an external diameter of the end portion of the outer cylinder 2 is made to be the same with an external diameter of the general portion, whereby thickness of the first diameter expanding portion 2A is made to be thinner than thickness of the general portion while thickness of the second diameter expanding portion 2B is made to be thinner than the thickness of the first diameter expanding portion 2A.

To perform a processing method of the present invention, as shown in FIG. 1, the following should be prepared in advance: a base tube 10 with the inner and outer diameter of the general portion of the outer cylinder 2; and a mandrel 11 capable to press-in an end portion of the base tube 10. Here, a kind of the base tube 10 can be optionally chosen; the based tube 10 may be a seamless tube or a welded tube. In case that an electroseamed tube is applied as the welded tube, caution should be given. An outer periphery surface of the electroseamed tube is smooth, but the inner periphery surface thereof has weld beads such as convex beads or concave beads thereon.

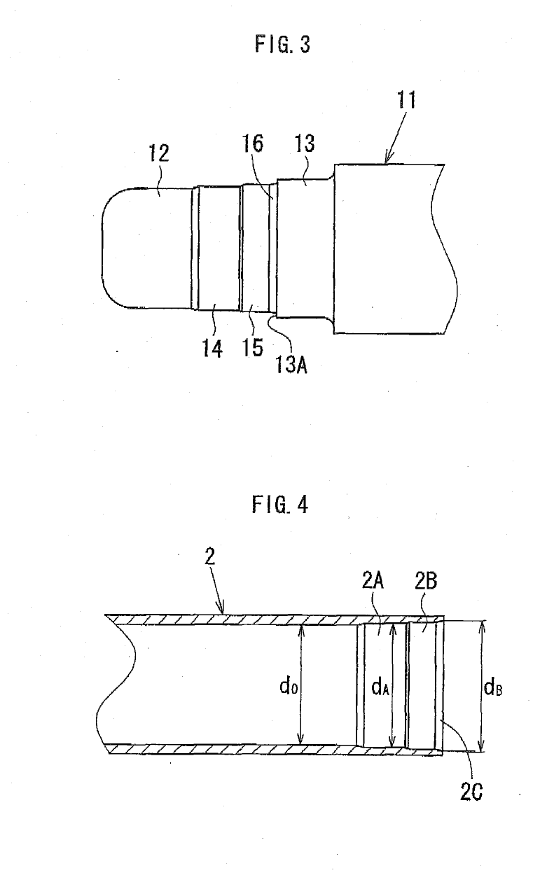

The mandrel 11 is provided with, as well shown in FIG. 3, a minimum diameter portion 12 placed at the most tip thereof and a maximum diameter portion 13 placed at the most base thereof opposite to the minimum diameter portion 12. Between the minimum diameter portion 12 and the maximum diameter portion 13, the following forming portions are provided in continuity: a first forming portion 14 having the same diameter of the inner diameter dA of the first diameter expanding portion 2A; a second forming portion 15 having the same diameter of the inner diameter dB of the second diameter expanding portion 2B; and a taper formation 16 having the same formation with the taper surface 2C. The minimum diameter portion 12 of the mandrel 11 has an external diameter slightly smaller than the inner diameter of the base tube 10 while the maximum diameter portion 13 has an external diameter approximately the same with an external diameter of the base tube 10. Further, between the taper formation 16 and the maximum diameter portion 13, an abutting portion 13A, to which the end portion of the base tube 10 is abutted when the mandrel 11 is pressed into the base tube 10, is provided.

Hereinafter, embodiments of the processing method of the present invention will be described according to figures. First, as shown in FIG. 1A, a base portion of the base tube 10 is to be supported by a chuck 21 of a chuck unit 20 provided within a rotation ironing process apparatus while the mandrel 11 is to be supported by a pressurized device (not shown) shiftable relative to the chuck unit 20. This FIG. 1A is thus regarded as a retaining process in the present invention. The rotation ironing process apparatus is provided with a pair of roller dies 22/22, each of the roller dies 22/22 is rotatable and placed to face each other with the base tube 10 retained by the chuck 21 between. The pair of roller dies 22/22 is supported by a driving device (not shown), so that each of the pair of roller dies 22/22 can come closer toward or away from each other. Further, the roller dies 22/22 are shiftable in parallel along the base tube 10. This roller dies 22/22 are not directly provided with a driving apparatus but is rotated by rotation of the base tube 10, that is, by friction between the roller dies 22/22 and the base tube 10. Here, needless to say, it is optional to provide the driving apparatus directly to the roller dies 22/22 so as to rotate the roller dies 22/22 by their own.

Next, as shown in FIG. 1B, the mandrel 11 is pressed into a tip end portion (the most end portion where mandrel 11 is inserted) of the base tube 10 retained by the chuck 21. The press-in of the mandrel 11 should be performed in consideration that the base tube 10 will be extended following a rotation ironing process; a certain clearance should be thus provided between the abutting portion 13A of the maximum diameter portion 13 and the tip end portion of the base tube 10. Accordingly, the inner surface of the end portion of the base tube 10 is to be expanded so as to make a stepped formation by means of the first and second forming portion 14/15 of the mandrel 11 (hereinafter the end portion means the portion where the stepped formation is formed). This process shown in FIG. 1B will be regarding as a tube-expanding process of the present invention.

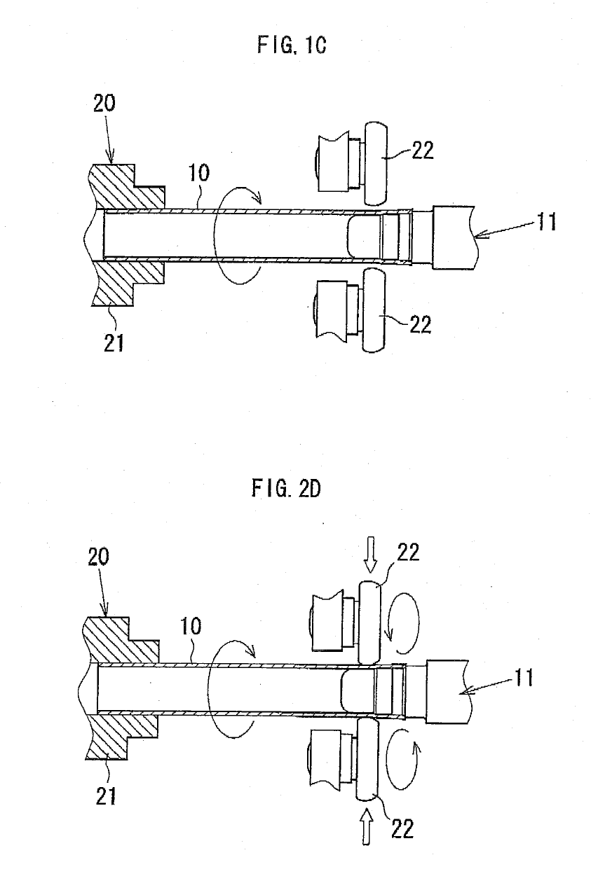

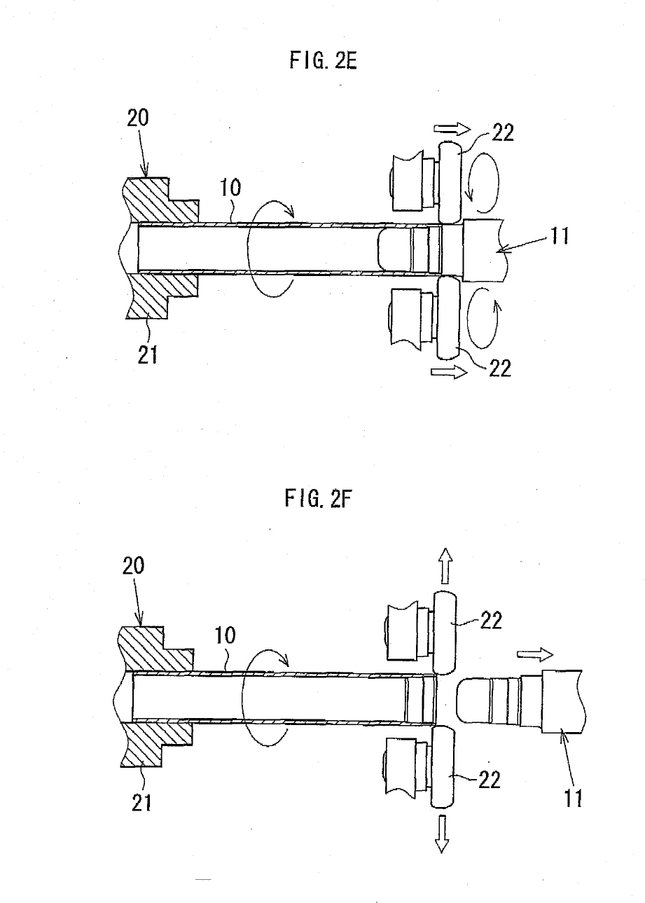

Following the tube expanding process described above, as shown in FIG. 1C, the chuck unit 20 will rotate the base tube 10 in a predetermined speed, and then, as shown in FIG. 2D, the pair of roller dies 22/22 is each shifted toward each other. The roller dies 22/22 then abut to a portion adjacent to the end portion of the base tube 10. Through this abutment, each of the roller dies 22/22 will roll over the outer periphery of the base tube 10 rotated. Next, as shown in FIG. 2E, the pair of the roller dies 22/22 are shifted in parallel toward the tip end portion of the base tube 10. Ironing will be thus performed over the end portion of the base tube 10 by the pair of the roller dies 22/22 in collaboration with the mandrel 11. With this ironing process, the outer periphery of the end portion of the base tube 10 evenly flattens to be equal to the outer periphery of the general portion of the base tube 10, whereby thickness of the end portion of the base tube 10 can be also reduced at the same time. On the other hand, the inner surface of the end portion of the base tube 10 is finished to have a multistage formation according to the nose portion of the mandrel 11 having the stepped formation hereinbefore described. These sequential processes shown in FIG. 1C, FIG. 2D and FIG. 2E will be regarded as a rotation ironing process of the present invention.

The pair of roller dies 22/22 will stop its shift when reaching to the maximum diameter portion 13 of the mandrel 11, and then, as shown in FIG. 2F, the mandrel 11 is pulled out from the base tube 10 while the pair of the roller dies 22/22 are shifted so as to be detached from each other. The sequential work over the end portion of the base tube 10 is here completed.

The outer cylinder 2 finished through the above process has its inner surface of the end portion, as shown in FIG. 4, with the desired stepped formation sequentially provided with the first diameter expanding portion 2A, the second diameter expanding portion 2B and the tape surface 2C. The inner roughness of the processed end portion of the outer cylinder 2 will be also in a good condition. Accordingly, the rod guide 4 and the oil seal 5 can be smoothly fitted into the end portion of the outer cylinder 2.

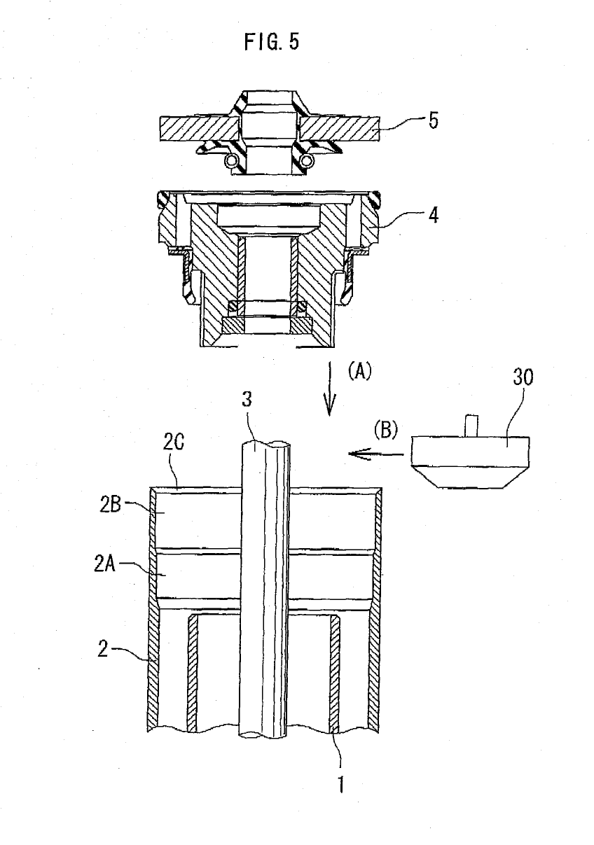

Hereinbelow, assembling processes of the rod guide 4, etc. and a curling process are explained with reference to FIG. 5

First, the inner cylinder 1 sub-assembled with the bottom valve BV is inserted into the outer cylinder 2, and then the piston rod 3 installed with the piston 8 and the piston valve PV is inserted into the inner cylinder 1. Next, the rod guide 4 sub-assembled with all kinds of seals or a guide bushing is inserted into the piston rod 3 so as to fit the rod guide 4 to the piston rod 3. At this time the oil seal 5 is also inserted. If necessary, oil or gas can be enclosed.

Second, while abutting a roller 30 over the tip end portion of the outer cylinder 2, the outer cylinder 2 is rotated so as to perform a full-curling process. Here, it is not necessary to perform the full-curling process as shown in figures, but another processes can be applied such as: an oscillating curl process producing a full-curling by rotating inclined dies and abutting the dies over the end surface of the outer cylinder 2; or a process producing partial curling portions by partially caulking the outer cylinder 2, may be 4 portions, in a circumferential direction. That is, as long as the parts such as the rod guide 4 are not pulled out from the outer cylinder 2, any methods (curling the tip end portion of the outer cylinder 2 inside) can be applied. Here, thickness of the second diameter expanding portion 2B is considerably reduced whereby the second diameter expanding portion 2B is hardened due to advancement of a structural denseness; however, it does not affect facilitation of the curling process. Especially, in the oscillating curl process, advancement of the structural denseness hereinabove described is prominent; however, by performing the above-described oscillating curl process in a full circumference, the full-curling can be performed in such a manner as to squash the structurally dense portions (hardened portions) in an axial direction. Accordingly, bending of the bended segment 2a (FIG. 12) can be easily and smoothly performed.

In general vehicle shock absorbers (cylinder devices), it is usual to use a tube having thickness approximately between 2.5 mm to 3.5 mm. Considering such a tube, and supposing a thickness reduction rate of a cylinder as more than 30%, it is still possible to obtain the high strength tube without cracks with the oscillating curl process in a full circumference. Further, necessary removing force of a sealing means including rod guides or seals in a vehicle shock absorber is 25 kN in general. In the above case of the oscillating curl process, the removing force more than 25 kN can be obtained.

Further, the following result has been verified by experiments: 1) removing force of 42 kN can be obtained in case that thickness is 2.5 mm and a thickness reduction rate is 35%; 2) removing force of 60 kN can be obtained in case that thickness is 2.9 mm and a thickness reduction rate is 41%; and removing force of 65 kN can be obtained in case that thickness is 3.2 mm and a thickness reduction rate is 47%. Here, if the thickness reduction rate is too high, it is possible to get materials too hardened thereby occurring cracks. Based on this result, the upper limit of the thickness reduction rate should be set approximately 50%.

The first diameter expanding portion 2A functioning as the fitting portion of the rod guide 4 is secured with enough thickness, whereby strength deterioration thereof is limited, and there is no problem for strength with respect to the outer cylinder 2. On the other hand, the external diameter of the outer cylinder 2 is finished to have a evenly flat surface with the outer periphery of the general portion of the base tube 10, the cap 7 conventionally applied can be used as it is. See FIG. 12. In addition, since weld beads are pressed into flat with the rotation ironing process, welded tubes can be applied as the base tube 10 with no qualitative negative impact. Accordingly, those welded tubes at less price can be used, contributing to the reduction of manufacturing cost.

In the above first embodiment, the mandrel 11 with two steps made by the first forming portion 14 and the second forming portion 15 having different diameters was applied, but the number of the steps provided at the nose of the mandrel 11 is optional. If desired for thinner tubes, only one step may be applied, or if desired for more thick tube, three steps or more can be applied.

Further, in the embodiments hereinabove described, the pair of the roller dies 22/22 facing toward each other is used for the rotation ironing process; however, the number of the roller die 22 to be provided is also optional. Three roller dies 22 may be applied. Here, in case three roller dies 22 or more are applied, those roller dies 22 should be evenly arranged around the base tube 10. In addition, the present invention is applicable with a planetary ball die instead of the roller die.

In the first embodiment, the roller dies 22/22 are shifted along the base tube; however, the present invention is not limited thereto. Instead, the base tube itself may be shifted without shifting the roller dies 22/22 in an axial direction.

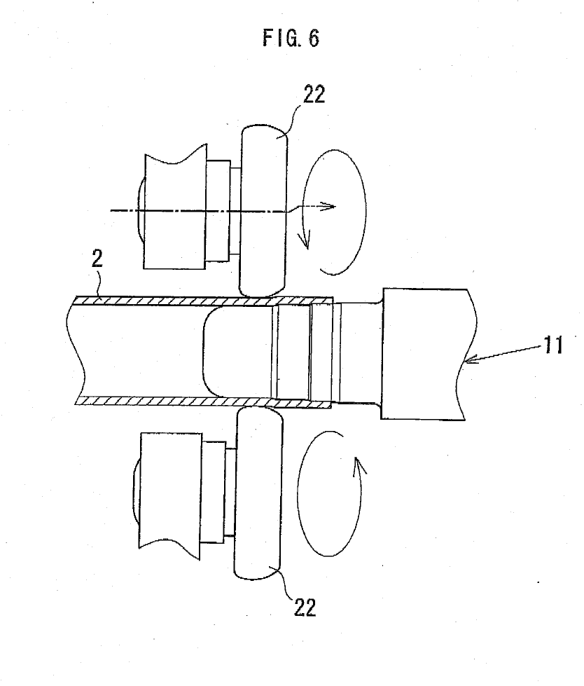

Still further, in the first embodiment, shift of the rotating shaft of the roller dies 22/22 in a radial direction is restricted while the roller dies 22/22 shift in an axial direction. The inner surface of the base tube 10 is thus processed to form the outer shape of the mandrel 11, and the outer diameter of the base tube 10 is formed evenly. The present invention is not limited to the above structure, but for example, as shown with a long dashed short dashed line in FIG. 6, the roller dies 22/22 may be shifted in the axial and radial directions along the mandrel 11, enabling to decrease a reduction rate of tube thickness. By adjusting the shifting amount in a radial direction, the reduction rate of the tube thickness can be controlled.

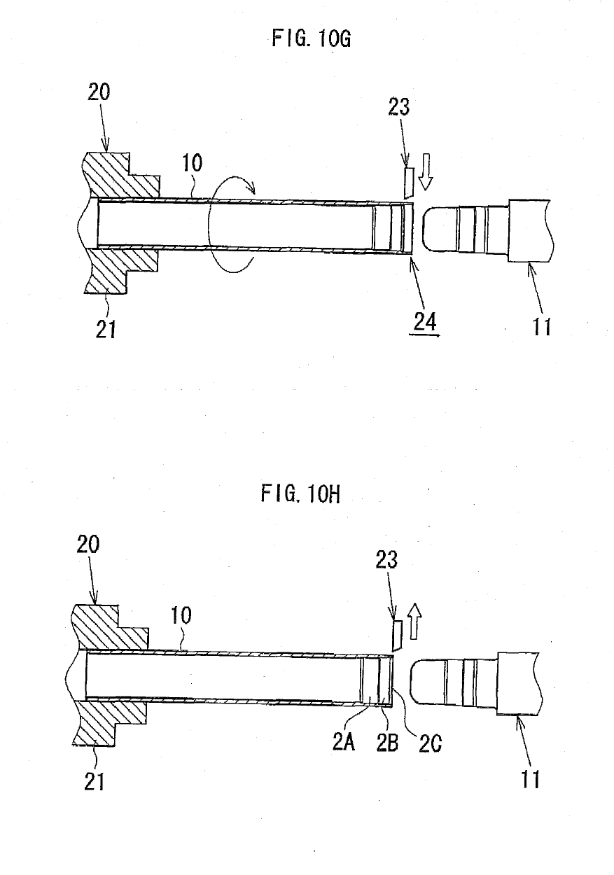

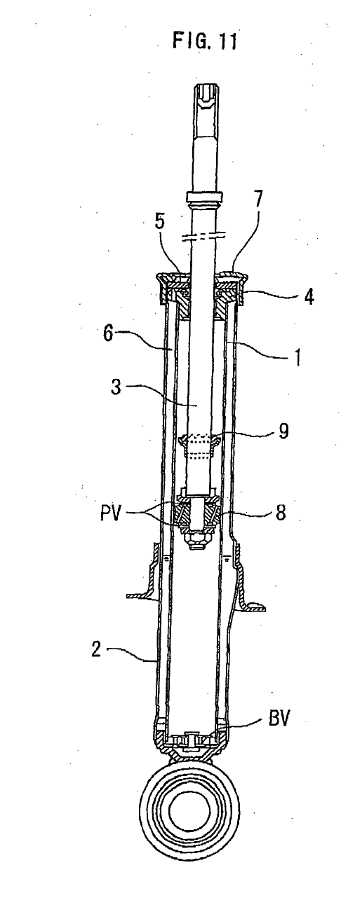

In case that the reduction rate of the tube thickness is modified and if the outer diameter of the base tube 10 needs to be even, cutting work may be performed on the outer periphery of the base tube 10 (cutting process). In this case, a tool bit 23 (hereinafter described in details) as shown in FIG. 10 can be shifted in an axial direction along the base tube 10.

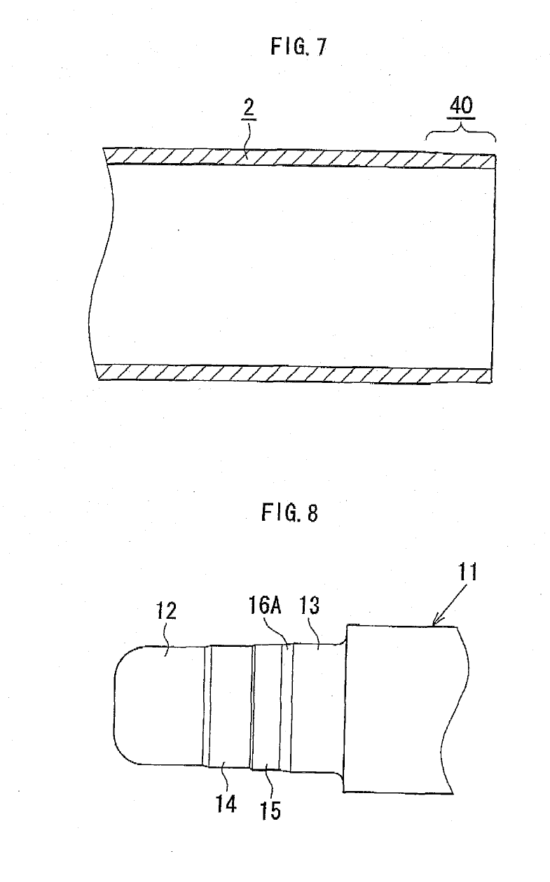

Furthermore, the reduction rate of the tube thickness can be also modified by a method shown in FIG. 7. That is, the outer periphery of an end portion 40 of the outer cylinder 2 (tube body) is cut in advance so as to reduce the outer diameter of the outer cylinder 2 (diameter reduction process). and then the same process in the first embodiment is applied.

Next, a processing method of a tube body in a second embodiment will be described with reference to FIGS. 8 to 10. The same components as those in the first embodiment are designated by the same reference numerals, and explanations thereto will be omitted. In the second embodiment, as shown in FIG. 8, the taper formation 16 and the abutting portion 13A in the first embodiment are modified to be a diameter expanding portion 16A connecting the taper formation 16 and the abutting portion 13A with a smooth inclined surface.

In the second embodiment, as the same with the process shown in FIG. 1A, the base portion of the base tube 10 is to be supported by the chuck 21 of the chuck unit 20 provided within the rotation ironing process apparatus while the mandrel 11 is to be supported by a pressurized device (not shown) shiftable relative to the chuck unit 20. This FIG. 1A is thus the retaining process in the present invention. The rotation ironing process apparatus is provided with the pair of roller dies 22/22, each of the roller dies 22/22 is rotatable and placed to face each other with the base tube 10 retained by the chuck 21 between. The pair of roller dies 22/22 is supported by the driving device (not shown), so that each of the pair of roller dies 22/22 can come closer toward or away from each other. Further, the roller dies 22/22 are shiftable in parallel along the base tube 10. those roller dies 22/22 are not directly provided with a driving apparatus but rotated by rotation of the base tube 10, that is, by friction between the roller dies 22/22 and the base tube 10. Here, it is optional to provide the driving apparatus directly to the roller dies 22/22 so as to rotate the roller dies 22/22 by their own.

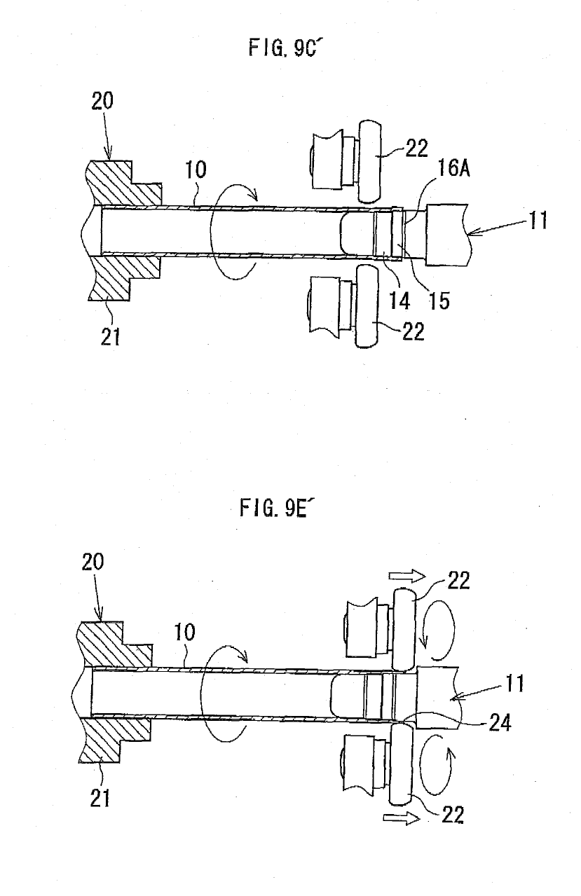

Next, as shown in FIG. 9C′, the mandrel 11 is pressed into the tip end portion of the base tube 10 retained by the chuck 21. The press-in of the mandrel 11 is performed until the end portion of the base tube 10 is abutted to the diameter expanding portion 16A (abutting portion 13A) Accordingly, the inner surface of the end portion of the base tube 10 is to be expanded into a stepped formation by the first and second forming portions 14/15 of the mandrel 11 (tube-expanding process). The base tube 10 will be rotated through operation of the chuck unit 20 at a predetermined speed.

Following the tube-expanding process, the pair of roller dies 22/22 is each shifted toward each other and then abut to a portion adjacent to the end portion of the base tube 10. Through this abutment, each of the roller dies 22/22 will roll over the outer periphery of the base tube 10 rotated and shift in parallel toward the tip end portion of the base tube 10. See FIG. 9 E′. Ironing will be thus performed over the end portion of the base tube 10 by the pair of the roller dies 22/22 in collaboration with the mandrel 11. With this ironing process, the outer periphery of the end portion of the base tube 10 evenly flattens to be equal to the outer periphery of the general portion of the base tube 10, whereby thickness of the end portion of the base tube 10 can be also reduced at the same time. On the other hand, the inner surface of the end portion of the base tube 10 is finished to have a multistage formation according to the nose portion of the mandrel 11 having the stepped formation. These sequential processes shown in FIG. 9C′ and FIG. 9E′ will be regarded as a rotation ironing process of the present invention. In the second embodiment, the tip end of the base tube 10 is extended along the diameter expanding portion 16A so as to form a thin padding portion 24.

In FIG. 10G, the tool bit 23 is abutted to the base tube 10 from a radially outward direction so as to cut the thin padding portion 24 (end cutting process). As a result, as shown in FIG. 10H, a desired stepped portion, wherein the inner end surface of the base tube 10 has the first diameter expanding portion 2A, the second diameter expanding portion 2B and the taper surface 2C formed in continuity, is finished. The rest of the procedure is the same with the first embodiment.

In case that low-cost welded tubes are used, it is possible that sizes thereof may not be constant so that processes of the end portion of the base tube 10 may be hampered in the first embodiment. However, in the second embodiment, even if the sizes of the base tube 10 are each different, the processes can be adjusted by cutting the thin padding portion 24. Accordingly, tubes with less accuracy can be applied. The other functional effects are the same with the first embodiment, whereby detail explanation will be omitted.

What is claimed is:

1. A manufacturing method of a cylinder device comprising the steps of:
a tube-expanding step wherein a base tube is partially retained with a chuck unit having a rotational function, and a mandrel is pressed in to an end portion of the base tube so as to expand the end portion of the base tube;
a rotation ironing step wherein the chuck unit rotates the base tube together with the mandrel, a roller die is pressed against an outer-periphery surface of the end portion of the base tube and the roller die is moved with respect to the base tube and in an axial direction thereof so as to deform an inner-periphery surface of the end portion of the base tube into a shape corresponding to an external shape of the mandrel;
a cutting step for cutting the outer periphery surface of the end portion of the base tube following the rotation ironing step;
an assembling step of assembling interior parts including a piston, a piston rod and a rod guide into the base tube; and
a curling process of curling a tip end portion of the base tube so as to prevent the interior parts from falling off.

2. A manufacturing method of the cylinder device according to claim 1, wherein the end portion of the base tube is configured to have an interior surface including a first diameter expanding portion and a second diameter expanding portion, the second diameter expanding portion being positioned by facing a tape surface and having a diameter larger than one of the first diameter expanding portion, and wherein the rod guide is fitted into the first diameter expanding portion.

3. A manufacturing method of the cylinder device according to claim 2, wherein an oil seal is fitted into the second diameter expanding portion.

4. A manufacturing method of the cylinder device according to claim 2, wherein processing of the second diameter expanding portion is performed in the curling process.

5. A manufacturing method of the cylinder device according to claim 1, wherein a thickness of the end portion of the base tube is reduced in the rotation ironing step.

6. A manufacturing method of the cylinder device according to claim 5, wherein the roller die is moved toward a tip end portion of the base tube in an axial direction in the rotation ironing step.

7. A manufacturing method of the cylinder device according to claim 5, wherein the roller die is moved toward a tip end portion of the base tube in an axial direction as well as in a radius direction in the rotation ironing step.

8. A manufacturing method of the cylinder device according to claim 6, wherein the mandrel includes: a press-in portion pressed into the base tube; and an abutting portion having a larger diameter than the one of the press-in portion, the abutting portion being adapted to abut to the tip end portion of the base tube following the rotation ironing step.

9. A manufacturing method of the cylinder device according to claim 8, wherein the abutting portion tapers, the diameter of which becomes wider in the axial direction away from the press-in portion.

10. A manufacturing method of the cylinder device according to claim 1, further comprising an end cutting step in which excess material of the end portion of the base tube is cut off following the rotation ironing step.

11. A manufacturing method of the cylinder device according to claim 1, wherein a press-in portion of the mandrel that is pressed into the base tube has a multi-stepped formation including at least two steps, the multi-stepped formation gradually becoming wider from an insertion end of the mandrel.

12. A manufacturing method of the cylinder device according to claim 1, further comprising a step of decreasing an external diameter of the end portion of the base tube before the mandrel is pressed in.
